(19) United States
(12) Patent Application Publication
(10) Pub. No.: US 2013/0279019 A1
(43) Pub. Date: Oct. 24, 2013

(54) ZOOMING LENS

(71) Applicant: Tsan-Haw Lee, Taichung City (TW)

(72) Inventor: Tsan-Haw Lee, Taichung City (TW)

(21) Appl. No.: 13/680,113

(22) Filed: Nov. 19, 2012

(30) Foreign Application Priority Data
Apr. 24, 2012 (TW) 101114589

(51) Int. Cl. G02B 15/14

(52) U.S. Cl. CPC G02B 15/14
USPC 359/691

(57) ABSTRACT

A zooming lens including a first lens group and a second lens group arranged in sequence from an object side to an image side is provided. The first lens group has negative optical power and includes a negative concave-convex lens and a positive concave-convex lens arranged in sequence from the object side to image side. A convex surface of the negative concave-convex lens is facing toward the object side and a convex surface of the positive concave-convex lens is facing toward the object side. The second lens group has positive optical power and includes a positive convex lens, a negative biconcave lens and a positive biconvex lens arranged in sequence from the object side to image side. The first and second lens groups are movable between the object side and image side for switching the zooming lens between a wide-angle mode, a middle mode and a telephoto mode.

### CROSS-REFERENCE TO RELATED APPLICATION

This application claims the priority benefit of Taiwan application serial no. 101114589, filed on Apr. 24, 2012. The entirety of the above-mentioned patent application is hereby incorporated by reference herein and made a part of this specification.

### BACKGROUND

1. Technical Field

The invention generally relates to a lens, and more particularly to a zooming lens.

2. Related Art

As technology advances, many video and image capturing devices such as the projector, the digital video camera (DVC), and the digital camera have been developed.

The zooming lens is one of the important components in these types of imaging devices. By moving different lens groups in the zooming lens, the focal length of the zooming lens accordingly changes, so as to increase the flexibility of the zooming lens in applications. Conventionally, the zooming lens typically employ multiple lens group movements to enable the zooming operation.

However, the zooming lens adopting multiple group movements require the use of many optical components. Due to the many included optical components in the zooming lens, the optical length of the zooming lens cannot be shortened, and the price of the zooming lens cannot be reduced. On the other hand, if the number of optical components included in the zooming lens decreases, the optical design freedom becomes limited, and the corresponding optical design increases in difficulty.

### SUMMARY

The invention provides a zooming lens capable of using fewer optical components to achieve a zoom function and preferable optical characteristics with low production costs.

The invention provides a zooming lens including a first lens group and a second lens group arranged in sequence from an object side to an image side. The first lens group has negative optical power and includes a negative concave-convex lens and a positive concave-convex lens arranged in sequence from the object side to the image side. A convex surface of the negative concave-convex lens is facing toward the object side, and a convex surface of the positive concave-convex lens is facing toward the object side. The second lens group has positive optical power and includes a positive convex lens, a negative biconcave lens, and a positive biconvex lens arranged in sequence from the object side to the image side. Moreover, the first lens group and the second lens group are movable between the object side and the image side for switching the zooming lens between a wide-angle mode, a middle mode, and a telephoto mode.

According to an embodiment of the invention, the second lens group further includes a stop disposed between the positive convex lens and the negative biconcave lens.

According to an embodiment of the invention, a material of the first lens group includes plastic, and a material of the second lens group includes glass.

According to an embodiment of the invention, an effective focal length of the first lens group is f₁, an effective focal length of the zooming lens under the wide-angle mode is f_{w}, and the zooming lens satisfies:

$$2.0 < \vert \frac{{f}_{1}}{{f}_{w}} \vert < 2.30 .$$

According to an embodiment of the invention, an effective focal length of the second lens group is f₂, an effective focal length of the zooming lens under the wide-angle mode is f_{w}, and the zooming lens satisfies:

$$1.4 < \vert \frac{{f}_{2}}{{f}_{w}} \vert < 1.55 .$$

According to an embodiment of the invention, an effective focal length of the negative concave-convex lens of the first lens group is f_{L1}, an effective focal length of the zooming lens under the wide-angle mode is f_{w}, and the zooming lens satisfies:

$$1.4 < \vert \frac{{f}_{L 1}}{fw} \vert < 1.8 .$$

According to an embodiment of the invention, an effective focal length of the second lens group is f₂, a dispersion coefficient of the negative biconcave lens is v_{L4}, and the zooming lens satisfies:

$$0.9 < \vert \frac{{v}_{L 4}}{{f}_{2}} \vert < 1.07 .$$

According to an embodiment of the invention, an effective focal length of the first lens group is f₁, an index of refraction of the positive concave-convex lens is N_{L2}, and the zooming lens satisfies:

$$0.038 < \vert \frac{{N}_{L 2}}{{f}_{1}} \vert < 0.052 .$$

According to an embodiment of the invention, an effective focal length of the first lens group is f₁, a dispersion coefficient of the positive concave-convex lens is v_{L2}, and the zooming lens satisfies:

$$0.5 < \vert \frac{{v}_{L 2}}{{f}_{1}} \vert < 0.75 .$$

Another embodiment of the invention provides a zooming lens including a first lens group having negative optical power and a second lens group having positive optical power arranged in sequence from an object side to an image side. The first lens group and the second lens group are movable between the object side and the image side for switching the zooming lens between a wide-angle mode, a middle mode, and a telephoto mode. Moreover, an effective focal length of the first lens group is f₁, an effective focal length of the zooming lens under the wide-angle mode is f_{w}, and the zooming lens satisfies:

$$2.0 < \vert \frac{{f}_{1}}{{f}_{w}} \vert < 2.30 .$$

In addition, an effective focal length of the second lens group is f₂, an effective focal length of the zooming lens under the wide-angle mode is f_{w}, and the zooming lens satisfies:

$$1.4 < \vert \frac{{f}_{2}}{{f}_{w}} \vert < 1.55 .$$

In summary, the zooming lens of the disclosure has a first lens group and a second lens group. The two lens group are movable, and plastic or glass fabricated aspheric lenses can be adopted in the first and second lens groups. By using the dual lens group framework, the number of optical components used and the production costs can be reduced. Moreover, the zooming lens can still achieve good switching between the wide-angle mode, the middle mode, and the telephoto mode. By using aspheric lenses, on the other hand, the optical length of the zooming lens can be effectively shortened and image aberrations can be corrected, thereby achieving preferable optical characteristics.

Several exemplary embodiments accompanied with figures are described in detail below to further describe the disclosure in details.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1A is a schematic view of a zooming lens according to an embodiment of the invention.

FIG. 1B is a schematic structural view of the zooming lens depicted in FIG. 1A under different modes.

FIGS. 2A-2D are optical simulation data diagrams of the zooming lens depicted in FIGS. 1A and 1B under different modes (wide-angle mode, middle mode, telephoto mode) according to the parameters listed in Tables 1-3.

### DESCRIPTION OF EMBODIMENTS

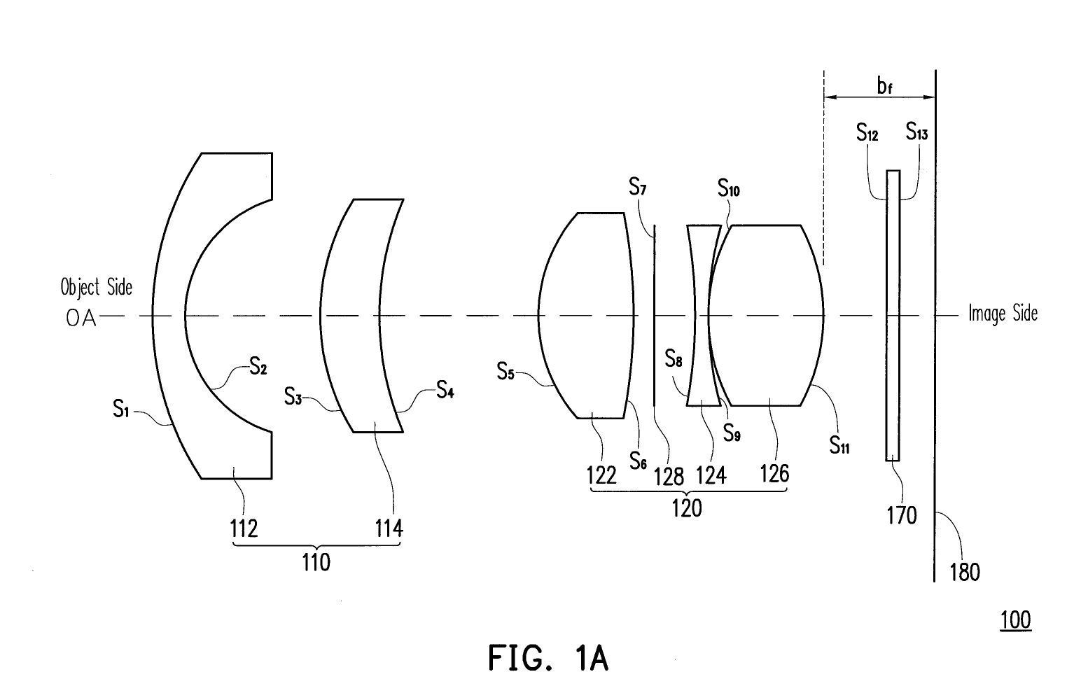

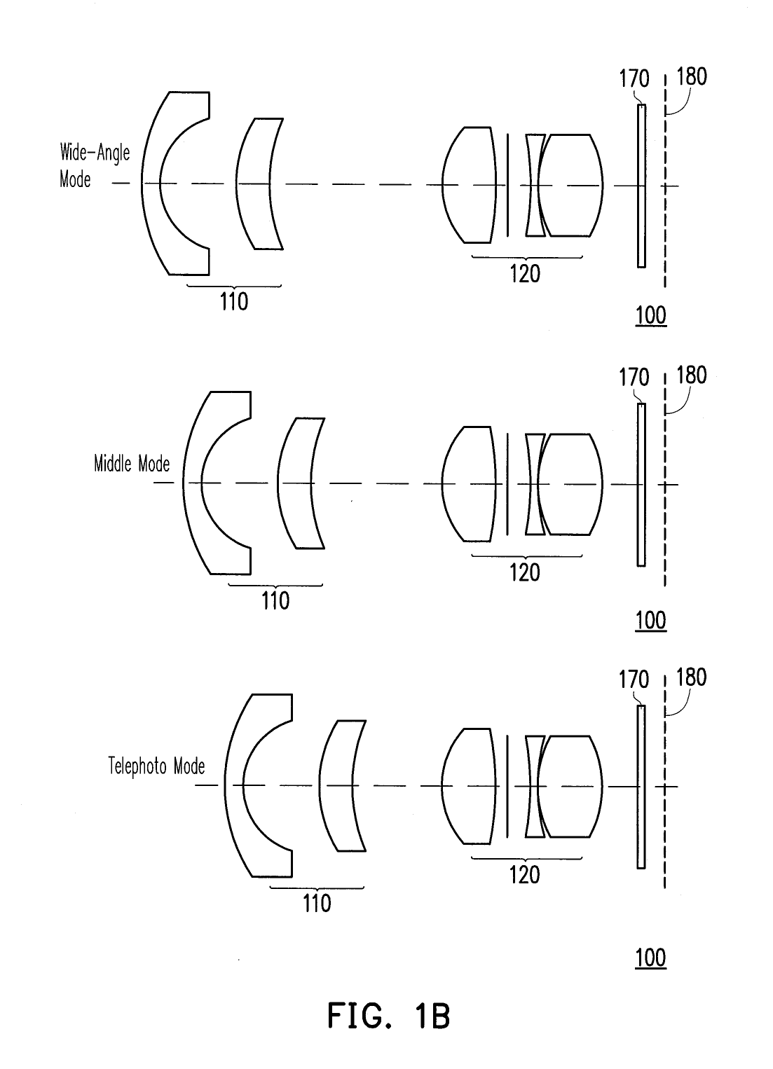

FIG. 1 is a schematic view of a zooming lens according to an embodiment of the invention. With reference to FIG. 1A, all of the optical components of a zooming lens 100 are arranged along an optical axis OA and between an object side and an image side. The zooming lens 100 includes a first lens group 110 and a second lens group 120 arranged in sequence from the object side to the image side. The first lens group 110 has negative optical power (i.e. negative refractive power) and includes a negative concave-convex lens 112 and a positive concave-convex lens 114 arranged in sequence from the object side to the image side. A convex surface of the negative concave-convex lens 112 is facing toward the object side, and a convex surface of the positive concave-convex lens 114 is facing toward the object side. The second lens group 120 has positive optical power (i.e. positive refractive power) and includes a positive convex lens 122, a negative biconcave lens 124, and a positive biconvex lens 126 arranged in sequence from the object side to the image side. The first lens group 110 and the second lens group 120 are movable between the object side and the image side for switching the zooming lens 100 between a wide-angle mode, a middle mode, and a telephoto mode.

According to one embodiment, in the zooming lens 100, the negative concave-convex lens 112 of the first lens group 110 may be an aspheric lens, and at least one of the positive convex lens 122 and the positive biconvex lens 126 in the second lens group 120 may be an aspheric lens.

By adopting a dual group moving mechanism for the first lens group 110 and the second lens group 120, the number of optical components used can be reduced. Moreover, aspheric lenses can be employed in the first lens group 110 and the second lens group 120, such that the optical length of the zooming lens 100 can be shortened and the image aberrations can be corrected, thereby achieving preferable optical characteristics.

To be specific, referring to FIG. 1A, the surfaces S1 and S2 of the negative concave-convex lens 112, the surfaces S5 and S6 of the positive convex lens 122, and the surfaces S10 and S11 of the positive biconvex lens 126 may all be aspheric surfaces used for eliminating image aberrations while achieving the technical effect of reducing the optical length of the zooming lens 100.

In addition, with regards to the lens materials, a material of the first lens group 110 may be plastic. That is, a material of the negative concave-convex lens 112 may be plastic. Moreover, a material of the second lens group 120 may be glass, which means that a material of at least one of the positive convex lens 122 and the positive biconvex lens 126 may be glass. In an situation, when the zooming lens 100 is used in a front projection projector having a non-telecentric system, since the negative concave-convex lens 112 is situated at a position far from a light source (not drawn, also the heat source), therefore, even if plastic is used to manufacture the negative concave-convex lens 112, the negative concave-convex lens 112 is not affected and degraded by heat from the light source, and thus the production costs can be reduced.

Moreover, since the positive convex lens 122 and the positive biconvex lens 126 are situated at a position near the light source, and both the positive convex lens 122 and the positive biconvex lens 126 can be made of glass, these lenses are more tolerant of high temperature and can maintain preferable optical characteristics.

In addition, with reference to FIG. 1A, the zooming lens 100 may also include a stop 128 disposed between the positive convex lens 122 and the negative biconcave lens 124, adapted for adjusting the imaging quality and controlling the light passing through the zooming lens 100.

Moreover, the zooming lens 100 may also include an optical component 170 disposed on one side of the positive biconvex lens 126 facing toward the image side. That is, the optical component 170 may be disposed between the surface S11 of the positive biconvex lens 126 and the image side. A transparent plate or an infrared filter may be adopted for the optical component 170. The infrared filter may be adapted for filtering an infrared light in the zooming lens 100, such that only visible light is allowed to pass through and a clear image is generated. The transparent plate may be a glass cover adapted for passing through visible light and protecting the optical modulating components (not drawn) which may be disposed on the image side.

On the image side, the zooming lens 100 may also include an optical modulating component (not drawn) disposed on an image surface 180 of the image side. An example of the optical modulating component may be the digital micro-mirror device (DMD) serving as an image source. If used in conjunction with other optical components, the zooming lens 100 may also be adapted for use in an image acquisition system.

FIG. 1B is a schematic structural view of the zooming lens depicted in FIG. 1A under different modes. In order to illustrate the relative positions of the first lens group 110 and the second lens group 120, only the first lens group 110 and the second lens group 120 are labeled in FIG. 1B. With reference to FIG. 1B, in the zooming lens 100, the first lens group 110 and the second lens group 120 are movable between the object side and the image side for adjusting a focal length of the zooming lens 100 and switching to different modes of the zooming lens 100.

As shown in FIG. 1B, according to the positional relationships between the first lens group 110 and the second lens group 120, the zooming lens 100 can be in a wide-angle mode, a middle mode, and a telephoto mode. In the example illustrated in FIG. 1B, a distance between the first lens group 110 and the second lens group 120 along the optical axis OA under the wide-angle mode is the greatest among the three modes. As the first lens group 110 and the second lens group 120 move toward each other along the optical axis OA, the zooming optical lens 100 switches to the middle mode or the telephoto mode as the distance between the first lens group 110 and the second lens group 120 gradually decreases.

That is, when the zooming lens 100 is switched from the wide-angle mode to the telephoto mode through passing the middle mode, an effective focal length of the zooming lens 100 gradually increases, such that a f-number (i.e., a ratio between the focal length and a diameter of the stop) also increases due to the added effective focal length (as shown in the subsequent Tables 3, 6, and 9). The overall optical length of the zooming lens 100 is accordingly reduced, but the back focal length of the zooming lens 100 gradually increases.

Under the dual group moving mechanism for the first lens group 110 (having negative optical power) and the second lens group 120 (having positive optical power), the zooming lens 100 can adjust the effective focal length to enhance the image clarity.

When the zooming lens 100 satisfies the following conditions, the zooming lens 100 can achieve a preferable correction effect for correcting each order of image aberrations. The optical design parameters and various implementations of the first lens group 110 and the second lens group 120 in the zooming lens 100 are further described hereafter. By satisfying conditions described in equations (1)-(7), the zooming lens 100 can achieve preferable optical properties.

For example, referring to FIG. 1A, when an effective focal length of the first lens group 110 is f₁, and an effective focal length of the zooming lens 100 under the wide-angle mode is f_{w}, a condition described in equation (1) which can be satisfied is:

$$2.0 < \vert \frac{{f}_{1}}{{f}_{w}} \vert < 2.30 \qquad ( 1 )$$

By satisfying equation (1), the optical configuration of the first lens group 110 in the zooming lens 100 is optimized under the wide-angle mode.

Moreover, when an effective focal length of the second lens group 120 is f₂, and the effective focal length of the zooming lens 100 under the wide-angle mode is f_{w}, a condition described in equation (2) which can be satisfied is:

$$1.4 < \vert \frac{{f}_{2}}{{f}_{w}} \vert < 1.55 \qquad ( 2 )$$

By satisfying equation (2), the optical configuration of the second lens group 120 in the zooming lens 100 is optimized under the wide-angle mode.

Furthermore, when an effective focal length of the negative concave-convex lens 112 of the first lens group 110 is f_{L1}, and the effective focal length of the zooming lens 100 under the wide-angle mode is f_{w}, a condition described in equation (3) which can be satisfied is:

$$1.4 < \vert \frac{{f}_{L 1}}{fw} \vert < 1.8 \qquad ( 3 )$$

By satisfying equation (3), the optical configuration of the negative concave-convex lens 112 in the zooming lens 100 is optimized under the wide-angle mode.

In optical lens design, the index of refraction (N) and the dispersion coefficient (Abbe number, v) are two important parameters. An increase in the dispersion coefficient represents lower dispersion of light. Conversely, a decrease in the dispersion coefficient indicates higher dispersion of light. Based on the above, a suitable optical design can be applied towards the index of refraction and the dispersion coefficient of the positive concave-convex lens 114 in the first lens group 110, as well as the dispersion coefficient of the negative biconcave lens 124 in the second lens group 120 when designing the zooming lens 100.

For example, when a focal length of the second lens group 120 is f₂, and a dispersion coefficient of the negative biconcave lens 124 is v_{L4}, a condition described in equation (4) which can be satisfied is:

$$0.9 < \vert \frac{{v}_{L 4}}{{f}_{2}} \vert < 1.07 \qquad ( 4 )$$

By satisfying equation (4), the optical properties of the negative biconcave lens 124 in the second lens group 120 are optimized.

Moreover, when the focal length of the first lens group 110 is f₁, and an index of refraction of the positive concave-convex lens 114 is N_{L2}, a condition described in equation (5) which can be satisfied is:

$$0.038 < \vert \frac{{N}_{L 2}}{{f}_{1}} \vert < 0.052 \qquad ( 5 )$$

In addition, when the focal length of the first lens group 110 is f₁, and a dispersion coefficient of the positive concave-convex lens 114 is v_{L2}, a condition described in equation (6) which can be satisfied is:

$$0.5 < \vert \frac{{v}_{L 2}}{{f}_{1}} \vert < 0.75 \qquad ( 6 )$$

By satisfying equations (5) and (6), the optical properties of the positive concave-convex lens 114 in the first lens group 110 are optimized.

With reference to FIG. 1A, in the zooming lens 100, a distance from the surface S11 of the positive biconvex lens 126 facing toward the image side to the image surface 180 can be viewed as a back focal length bf of the zooming lens 100. Moreover, in the zooming lens 100, the light passing through a range defined by the diameter of the stop 128 can leave the zooming lens 100 and arrive at the image surface 180. Furthermore, in the zooming lens 100, a system exit pupil position ex is at a virtual optical surface (not drawn in FIG. 1A).

When the back focal length of the zooming lens 100 is bf, and the system exit pupil position is ex, a condition described in equation (7) which can be satisfied is:

$$1.35 < \vert \frac{ex}{bf} \vert < 1.5 \qquad ( 7 )$$

When equations (1)-(7) are satisfied, a total lens length of the zooming lens 100 can be effectively reduced, and image aberrations can be corrected. In particular, when equations (5)-(6) are satisfied, the resolving power of the zooming lens 100 can be significantly enhanced.

The related optical parameters of each optical component in the zooming lens 100 according to the present embodiment are exemplified hereafter. It should be noted that, the invention is not limited to the data listed in Tables 1, 2, and 3. It should be known to those ordinarily skilled in the art that various modifications and variations can be made to the optical parameters or the configurations without departing from the scope or spirit of the invention.

TABLE 1

| | Radius of | | | | |
|---|---|---|---|---|---|
| Surface | Curvature | Distance | Index of | Dispersion | |
| number | (mm) | (mm) | Refraction | Coefficient | Notes |
| S1 | 29.161 | 4.99 | 1.525 | 56.40 | Negative |
| | | | | | Concave- |
| | | | | | Convex Lens |
| | | | | | (112) |
| S2 | 8.9696 | 15.84 | | | |
| S3 | 25.591 | 4.31 | 1.805 | 25.43 | Positive |
| | | | | | Concave- |
| | | | | | Convex Lens |
| | | | | | (114) |
| S4 | 32.643 | Adjustable | | | |
| | | Distance (S4) | | | |
| S5 | 12.384 | 6.21 | 1.484 | 70.26 | Positive |
| | | | | | Convex Lens |
| | | | | | (122) |
| S6 | −50.234 | 1.48 | | | |
| STOP | ∞ | 3.63 | | | Stop (128) |
| (S7) | | | | | |
| S8 | −17.347 | 0.8 | 1.755 | 27.51 | Negative |
| | | | | | Biconcave |
| | | | | | Lens (124) |
| S9 | 21.881 | 0.15 | | | |
| S10 | 19.688 | 6.96 | 1.804 | 40.48 | Positive |
| | | | | | Biconvex |
| | | | | | Lens (126) |
| S11 | −28.518 | 20 | | | |
| S12 | ∞ | 1.05 | 1.487 | 70.24 | Optical |
| | | | | | Component |
| | | | | | (170) |
| S13 | ∞ | Adjustable | | | |
| | | Distance | | | |
| | | (S13) | | | |

In Table 1, the “Distance” refers to a linear distance between two neighboring surfaces on the optical axis OA. For example, “the distance of the surface S1” refers to the linear distance between the surface Si and the surface S2 on the optical axis OA (i.e., a thickness of the negative concave-convex lens 112 along the optical axis OA).

The distance, index of refraction, and the Abbe number of each optical component (negative concave-convex lens 112, positive concave-convex lens 114, positive convex lens 122, negative biconcave lens 124, positive biconvex lens 126, stop 128, and optical component 170) listed in the Notes column of Table 1 can be referenced to the numerical values corresponding to each distance, index of refraction, and Abbe number listed on the same row. By using the same defining principle of the distance, the thicknesses of the other optical components along the optical axis OA can be obtained. In particular, since the distances of surfaces S4 and S13 are adjustable, these distances are provided in Table 3.

Furthermore, referring also to FIG. 1A, in Table 1, STOP represents the stop 128; the surfaces S1 and S2 are two surfaces of the negative concave-convex lens 112; the surfaces S3 and S4 are two surfaces of the positive concave-convex lens 114; the surfaces S5 and S6 are two surfaces of the positive convex lens 122; the surface S7 is a stop; the surfaces S8 and S9 are two surfaces of the negative biconcave lens 124; the surfaces S10 and S11 are two surfaces of the positive biconvex lens 126; the surfaces S12 and S13 are two surfaces of the optical component 170. Moreover, the distance of the surface S13 is the distance from the surface S13 to the image surface 180.

Based on the above, in the present embodiment, the negative concave-convex lens 112, the positive convex lens 122, and the positive biconvex lens 126 may all be aspheric lenses. Therefore, the surfaces S1, S2, S5, S6, S10, and S11 may all be aspheric surfaces which can be defined by equation (8):

$$D = \frac{C \cdot {H}^{2}}{1 + \sqrt{1 - ( 1 + K ) \cdot {C}^{2} \cdot {H}^{2}}} + {E}_{4} {H}^{4} + {E}_{6} {H}^{6} + {E}_{8} {H}^{8} + {E}_{10} {H}^{10} + {E}_{12} {H}^{12} + {E}_{14} {H}^{14} + {E}_{16} {H}^{16} \qquad ( 8 )$$

In equation (8), D is the sag along the direction of the optical axis OA, and C is the reciprocal of the radius of the osculating sphere, which is also the reciprocal of the radius of curvature near the optical axis OA (e.g., the radius of curvatures for the surfaces S1, S2, S5, S6, S10, and S11 listed in Table 1). K is the 2^{nd} order conic coefficient, and H is the aspheric height, i.e., the height from the center to the edge of the lens. E₄-E₁₆ are the aspheric coefficients. The parameter values of the surfaces S1, S2, S5, S6, S10, and S11 are listed in Table 2.

TABLE 2

| Surface | | | | |
|---|---|---|---|---|
| Number | K | E4 | E6 | E8 |
| S1 | −12.2332 | −3.90E−05 | 1.83E−07 | −4.06E−10 |
| S2 | −0.76717 | −0.00014 | 6.49E−07 | −2.65E−09 |
| S5 | 0.022517 | −4.87E−06 | 7.81E−08 | 4.14E−10 |
| S6 | −52.666 | 1.44E−05 | 3.14E−07 | −3.60E−09 |
| S10 | 3.440496 | 3.47E−05 | −5.27E−07 | −9.84E−11 |
| S11 | −11.3517 | 5.75E−05 | 1.51E−06 | −1.35E−08 |
| Surface | | | | |
| Number | E10 | E12 | E14 | E16 |
| S1 | −2.54E−13 | 3.72E−15 | −8.01E−18 | 5.71E−21 |
| S2 | 5.12E−12 | −2.11E−14 | 1.46E−16 | −3.84E−19 |
| S5 | −3.67E−12 | 9.21E−14 | 0 | 0 |
| S6 | 2.56E−11 | −1.21E−13 | 0 | 0 |
| S10 | 1.20E−11 | −1.25E−12 | 0 | 0 |
| S11 | 4.59E−10 | −3.23E−12 | 0 | 0 |

The zooming lens 100 switches between the wide-angle mode, the middle mode, and the telephoto mode as the first lens group 110 and the second lens group 120 move between the object side and the image side. Therefore, parameters such as the effective focal length (EFL) and the f-number have different values in different modes. Table 3 lists some important parameter values of the zooming lens 100 under different modes.

TABLE 3

| | | Wide-Angle | Middle | Telephoto |
|---|---|---|---|---|
| | | Mode | Mode | Mode |
| EFL (mm) | | 16.9267 | 18.5964 | 20.0621 |
| f-number | | 2.5566 | 2.643 | 2.730 |
| Adjustable | S4 | 23.1348 | 17.87604 | 13.49374 |
| Distance | S13 | 3.428637 | 4.57372 | 5.71765 |

The adjustable distance listed in Table 3 refers to a linear distance between two neighboring surfaces on the optical axis OA. For example, “the adjustable distance S4” represents the adjusted linear distance between the surfaces S4 and S5 on the optical axis OA.

Since the first lens group 110 and the second lens group 120 of the zooming lens 100 move between the object side and the image side, the distance of the first lens group 110 and the second lens group 120 (i.e., the distance between the surface S4 of the positive concave-convex lens 114 and the surface S5 of the positive convex lens 130) changes as the first lens group 110 and the second lens group 120 are moved.

When the zooming lens 110 switches from the wide-angle mode to the telephoto mode through the middle mode, as the distance between the first lens group 110 and the second lens group 120 gradually decreases, the f-number and the effective focal length increase, as shown in Table 3.

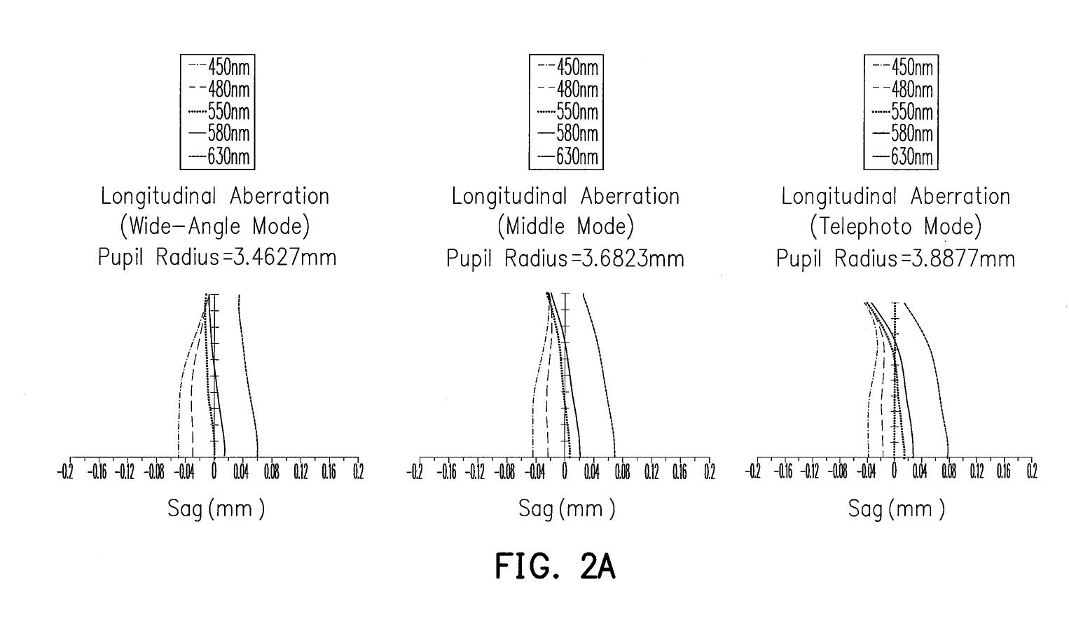

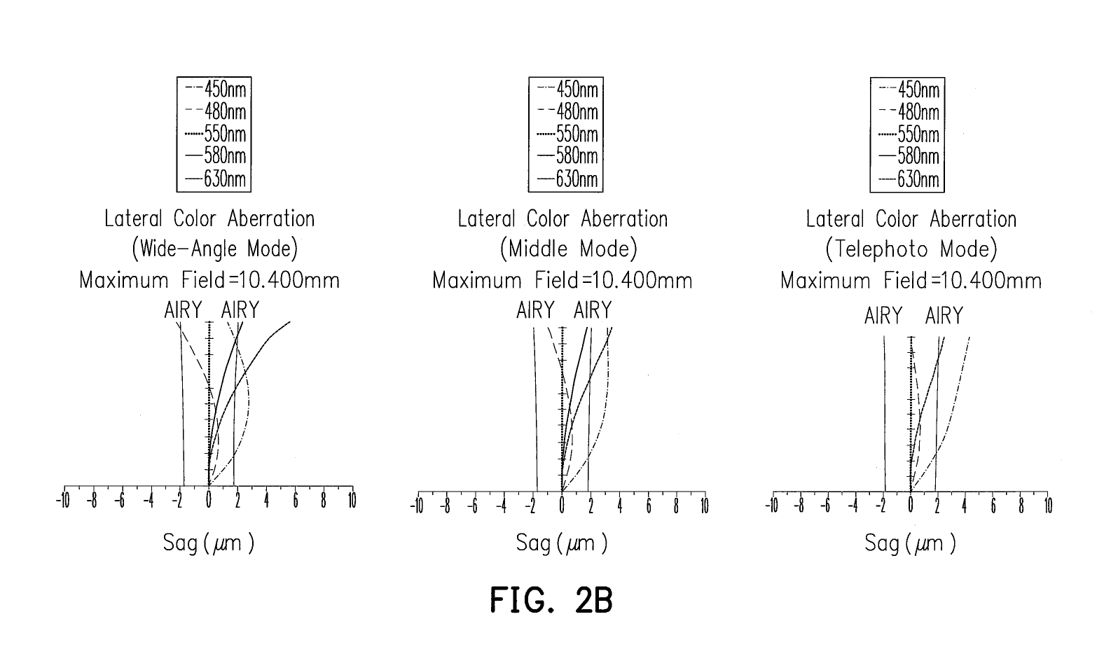

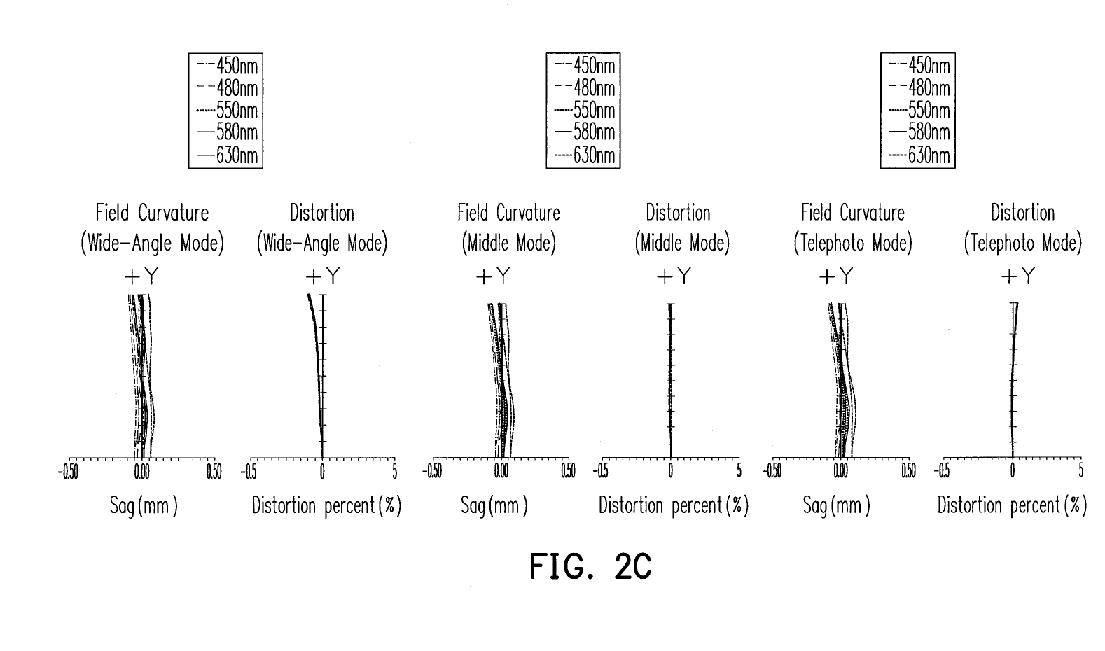

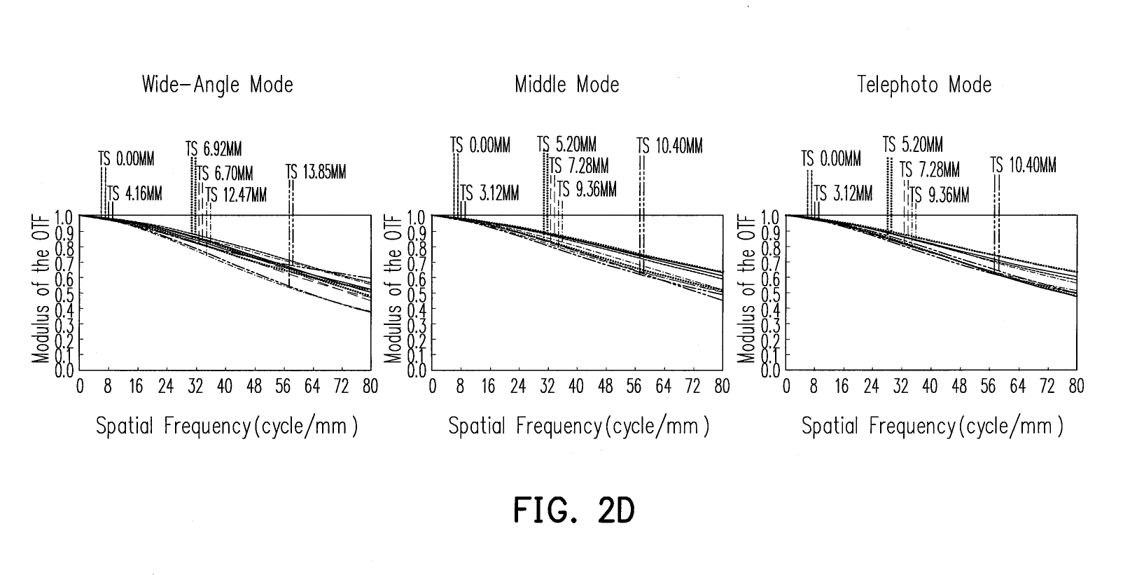

FIGS. 2A-2D are optical simulation data diagrams of the zooming lens depicted in FIGS. 1A and 1B under different modes (wide-angle mode, middle mode, telephoto mode) according to the parameters listed in Tables 1-3. FIG. 2A is a curve diagram of the longitudinal color aberration. FIG. 2B is a curve diagram of the lateral color aberration. FIG. 2C is a curve diagram of the field curvature and distortion. FIG. 2D is a modulation transfer function (MTF) diagram, in which the transverse axis is the spatial frequency in cycles/mm, and the longitudinal axis is the modulus of the optical transfer function (OTF).

The optical simulation data diagrams described above are all simulated with light having wavelengths of 450 nm, 480 nm, 550 nm, 580 nm, and 630 nm. As shown in the graphs of FIGS. 2A-2D, when the zooming lens 100 of this embodiment uses the parameters of Tables 1-3, a preferable imaging quality can be achieved.

Moreover, in the zooming lens 100 depicted in FIG. 1A, each of the first lens group 110 and the second lens group 120 have their respective optical lenses. That is, the first lens group 110 includes the negative concave-convex lens 112 and the positive concave-convex lens 114, and the second lens group 120 includes the positive lens 122, the negative biconcave lens 124, and the positive biconvex lens 126.

However, persons skilled in the pertinent art may adjust or design the type and quantity of the optical lenses included in the first lens group and the second lens group of the zooming lens, such that when at least equations (1) and (2) above are satisfied, the zooming lens can achieve a preferable zooming operation.

Another embodiment of the invention provides a zooming lens (not drawn) including a first lens group having negative optical power and a second lens group having positive optical power arranged in sequence from an object side to an image side. The first lens group and the second lens group are movable between the object side and the image side for switching the zooming lens between a wide-angle mode, a middle mode, and a telephoto mode. Moreover, when an effective focal length of the first lens group is f₁, an effective focal length of the zooming lens under the wide-angle mode is f_{w}, the zooming lens satisfies:

$$2.0 < \vert \frac{{f}_{1}}{{f}_{w}} \vert < 2.30 .$$

In addition, when an effective focal length of the second lens group is f₂, the effective focal length of the zooming lens under the wide-angle mode is f_{w}, the zooming lens satisfies:

$$1.4 < \vert \frac{{f}_{2}}{{f}_{w}} \vert < 1.55 .$$

The zooming lens adopts the dual group moving mechanism, such that by satisfying equations (1) and (2) for setting the focal lengths, the technical effects of the zooming lens in the disclosure can be achieved regardless of the lens type and quantity actually included in the first and second lens groups.

In view of the foregoing, the zooming lens in the disclosure at least has the following advantages:

By adopting the dual group moving mechanism for the first lens group (having negative optical power) and the second lens group (having positive optical power), and due to the inclusion of aspheric lenses in the first and second lens groups, the number of optical components used and productions costs can be reduced. Moreover, the optical length of the zooming lens can be effectively shortened and the image aberrations can be corrected, thereby achieving preferable optical characteristics.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A zooming lens, comprising in sequence from an object side to an image side:
a first lens group, having negative optical power and comprising a negative concave-convex lens and a positive concave-convex lens arranged in sequence from the object side to the image side, wherein a convex surface of the negative concave-convex lens is facing toward the object side, and a convex surface of the positive concave-convex lens is facing toward the object side; and
a second lens group, having positive optical power and comprising a positive convex lens, a negative biconcave lens, and a positive biconvex lens arranged in sequence from the object side to the image side,
wherein the first lens group and the second lens group are movable between the object side and the image side for switching the zooming lens between a wide-angle mode, a middle mode, and a telephoto mode.

2. The zooming lens as claimed in claim 1, wherein the second lens group further comprises:
a stop, disposed between the positive convex lens and the negative biconcave lens.

3. The zooming lens as claimed in claim 1, wherein,
a material of the first lens group comprises plastic; and
a material of the second lens group comprises glass.

4. The zooming lens as claimed in claim 1, wherein, an effective focal length of the first lens group is f₁, an effective focal length of the zooming lens under the wide-angle mode is f_{w}, and the zooming lens satisfies:
$$2.0 < \vert \frac{{f}_{1}}{{f}_{w}} \vert < 2.30 .$$

5. The zooming lens as claimed in claim 1, wherein, an effective focal length of the second lens group is f₂, an effective focal length of the zooming lens under the wide-angle mode is f_{w}, and the zooming lens satisfies:
$$1.4 < \vert \frac{{f}_{2}}{{f}_{w}} \vert < 1.55 .$$

6. The zooming lens as claimed in claim 1, wherein, an effective focal length of the negative concave-convex lens of the first lens group is f_{L1}, an effective focal length of the zooming lens under the wide-angle mode is f_{w}, and the zooming lens satisfies:
$$1.4 < \vert \frac{{f}_{L 1}}{fw} \vert < 1.8 .$$

7. The zooming lens as claimed in claim 1, wherein, an effective focal length of the second lens group is f₂, a dispersion coefficient of the negative biconcave lens is v_{L4}, and the zooming lens satisfies:
$$0.9 < \vert \frac{{v}_{L 4}}{{f}_{2}} \vert < 1.07 .$$

8. The zooming lens as claimed in claim 1, wherein, an effective focal length of the first lens group is f₁, an index of refraction of the positive concave-convex lens is N_{L2}, and the zooming lens satisfies:
$$0.038 < \vert \frac{{N}_{L 2}}{{f}_{1}} \vert < 0.052 .$$

9. The zooming lens as claimed in claim 1, wherein, an effective focal length of the first lens group is f₁, a dispersion coefficient of the positive concave-convex lens is v_{L2}, and the zooming lens satisfies:
$$0.5 < \vert \frac{{v}_{L 2}}{{f}_{1}} \vert < 0.75 .$$

10. The zooming lens as claimed in claim 1, wherein, a back focal length of the zooming lens is bf, a system exit pupil position is ex, and the zooming lens satisfies:
$$1.35 < \vert \frac{ex}{bf} \vert < 1.5 .$$

11. The zooming lens as claimed in claim 1, further comprising:
an optical component, disposed on one side of the positive biconvex lens facing toward the image side.

12. The zooming lens as claimed in claim 11, wherein, the optical component comprises a transparent plate or an infrared filter.

13. The zooming lens as claimed in claim 1, further comprising:
an optical modulating component, disposed on an image surface of the image side.

14. The zooming lens as claimed in claim 13, wherein, the optical modulating component comprises a digital micro-mirror device.

15. The zooming lens as claimed in claim 1, wherein,
a material of the negative concave-convex lens comprises plastic; and
a material of at least one of the positive convex lens and the positive biconvex lens comprises glass.

16. A zooming lens, comprising in sequence from an object side to an image side:
a first lens group, having negative optical power; and
a second lens group, having positive optical power,
the first lens group and the second lens group are movable between the object side and the image side for switching the zooming lens between a wide-angle mode, a middle mode, and a telephoto mode, an effective focal length of the first lens group is f₁, an effective focal length of the zooming lens under the wide-angle mode is f₂ and the zooming lens satisfies:
$$2.0 < \vert \frac{{f}_{1}}{{f}_{w}} \vert < 2.30 ;$$
and
an effective focal length of the second lens group is f₂, the effective focal length of the zooming lens under the wide-angle mode is f_{w}, and the zooming lens satisfies:
$$1.4 < \vert \frac{{f}_{2}}{{f}_{w}} \vert < 1.55 .$$
